(19) United States
(12) Patent Application Publication
(10) Pub. No.: US 2004/0090767 A1
(43) Pub. Date: May 13, 2004

(54) Decorative electro-luminescent strip for automobiles

(76) Inventor: Fu-Cheng Hou, Tainan City (TW)

Correspondence Address: Fu-Cheng Hou, P.O. Box 90, Tainan City, 704, TW

(21) Appl. No.: 10/291,502

(22) Filed: Nov. 12, 2002

(51) Int. Cl. F21V 9/16

(52) U.S. Cl. 362/84; 362/540; 362/485; 362/487

(57) ABSTRACT

A decorative electro-luminescent strip for automobiles in the present invention mainly includes a body, a tape placed in a groove of a back of the body, an electro-luminescent member disposed on a raised part of a recess of the body, and a transparent cover welded to the front of the body. Attach the decorative electro-luminescent strip to an automobile body with cords of the electro-luminescent member connected to power source of the automobile to make the electro-luminescent member emit luminescence capable of passing through the transparent cover to perform warning function in the night so that night drivers who often have bad view in the dark can immediately pay attention to the automobile when it is driven on the road or parked by the roadside to avoid car collisions, thus greatly increasing the safety of the automobile.

### BACKGROUND OF THE INVENTION

1. Field of the Invention

This invention relates to a decorative electro-luminescent strip for automobiles, particularly to one capable of being attached to an automobile body to produce a night-visual effect by making an electro-luminescent member emit luminescence capable of passing through a transparent cover to perform warning function in the night so that night drivers who often have bad view in the dark can immediately pay attention to the automobile when it is driven on the road or parked by the roadside, thus greatly increasing the safety of the automobile.

2. Description of the Prior Art

Generally speaking, most automobiles are not equipped with special night-warning means, but only have sidemarker lamps installed at both sides thereof. When the automobiles are driven in the night, only the sidemarker lamps can warn night drivers to pay attention to the existence and the possible driving routes of the automobiles for avoiding car collisions. However, such sidemarker lamps can not perform warning function when the automobiles are parked by the roadside because the sidemarker lamps are in turn-off status if the automobiles are not actuated, which always making the automobiles in danger, especially when the automobiles are parked by the roadside in the night. Moreover, It is evidenced that there are many parked automobiles being crashed in that situation because night drivers often have bad view in the dark.

### SUMMARY OF THE INVENTION

The main purpose of the present invention is to offer a decorative electro-luminescent strip for automobiles capable of performing warning function when automobiles are driven on the road or parked by the roadside in the night.

One primary feature of the present invention is to provide a decorative electro-luminescent strip for automobiles including:

a body having at least one groove disposed in a back thereof and a recess disposed in a front thereof, the recess provided with a raised part therein;

at least one tape placed in the at least one groove of the body;

an electro-luminescent member disposed on the raised part of the recess of the body and connected with cords at a lower portion thereof; and,

a transparent cover capable of being welded to the front of the body and provided with two projecting ridges respectively disposed at both sides of an inner surface thereof.

### BRIEF DESCRIPTION OF DRAWINGS

This invention will be better understood by referring to the accompanying drawings, wherein:

FIG. 1 is an exploded perspective view of a decorative electro-luminescent strip for automobiles in the present invention;

FIG. 2 is a perspective view of the decorative electro-luminescent strip for automobiles in the present invention; and,

FIG. 3 is a schematic view of the decorative electro-luminescent strip for automobiles in the present invention being in use.

### DETAILED DESCRIPTION OF THE PREFERRED EMBODIMENT

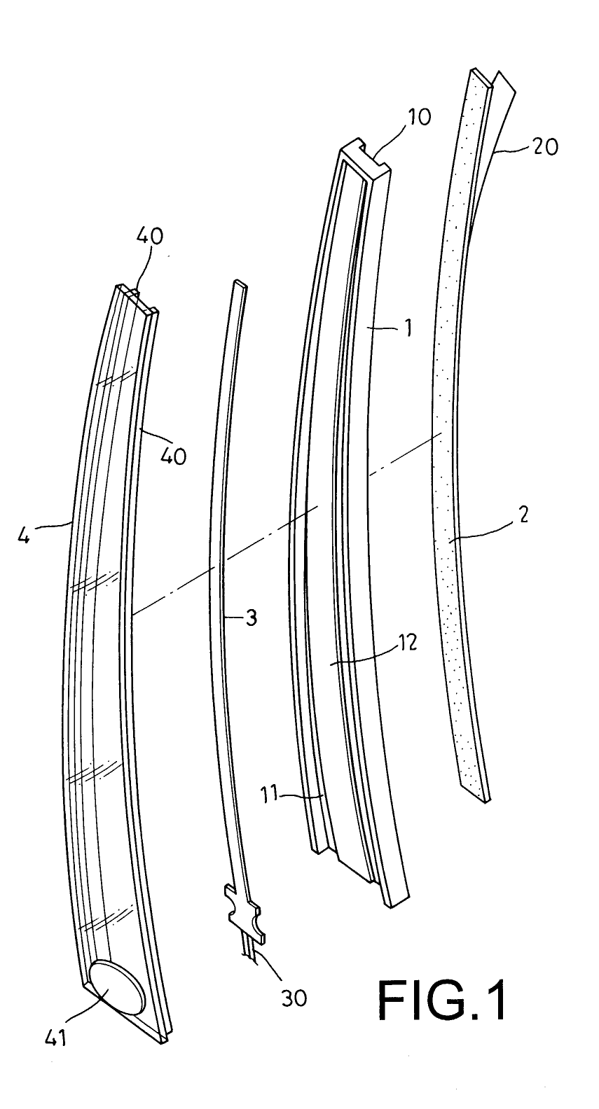

A preferred embodiment of a decorative electro-luminescent strip for automobiles in the present invention, as shown in FIG. 1, mainly includes a body 1, a tape 2, an electro-luminescent member 3 and a transparent cover 4.

The body 1 in longitudinal rectangular and curved shape is getting wider from top to bottom. A top surface and a bottom surface of the body 1 are provided to be inclined planes. Moreover, the body 1 has a groove 10 disposed in a back thereof and a recess 11 disposed in a front thereof. The recess 11 is provided with a raised part 12 therein.

The tape 2 placed in the groove 10 of the back of the body 1 has a sheet of paper 20 disposed at one side thereof and easily removed.

The electro-luminescent member 3 disposed on the raised part 12 of the recess 11 of the front of the body 1 is connected with cords 30 at a lower portion thereof.

The transparent cover 4 capable of being welded to the front of the body 1 has two projecting ridges 40 respectively disposed at both sides of an inner surface thereof and an opaque decorative piece 41 disposed adjacent a lower end thereof.

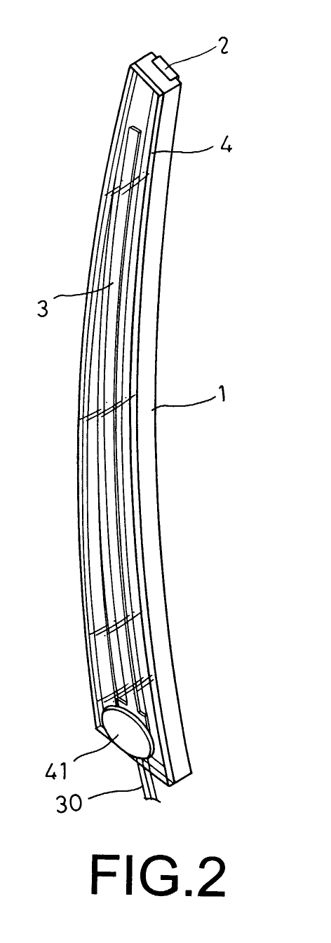

In assembling, referring to FIGS. 1 and 2, firstly fix the electro-luminescent member 3 on the raised part 12 of the recess 11 of the body 1 with the cords 30 extending outwardly from the lower portion of the electro-luminescent member 3. Secondly, place the transparent cover 4 on the front of the body 1 with the two projecting ridges 40 of the transparent cover 4 respectively engaged in two sidewalls of the recess 11 of the body 1, and then have the transparent cover 4 welded to the front of the body 1. Finally, attach the tape 2 to the back of the body 1, by which an assemblage of the whole structure of the decorative electro-luminescent strip for automobiles in the present invention is completed.

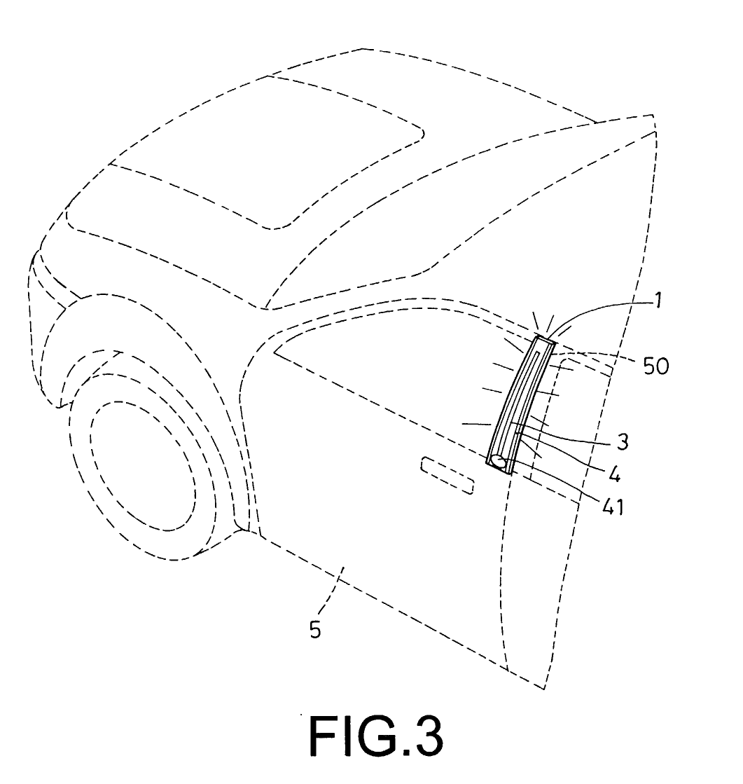

In using, referring to FIG. 3, firstly remove the sheet of paper 20 from the tape 2 of the decorative electro-luminescent strip. Secondly, attach the decorative electro-luminescent strip to a car body 50 of an automobile 5 with the cords 30 of the electro-luminescent member 3 connected to power source of the automobile 5 to make the electro-luminescent member 3 emit luminescence capable of passing through the transparent cover 4 to perform warning function in the night so that night drivers who often have bad view in the dark can immediately pay attention to the automobile 5 when it is driven on the road or parked by the roadside to avoid car collisions, thus greatly increasing the safety of the automobile 5.

While the preferred embodiment of the invention have been described above, it will be recognized and understood that various modifications may be made therein and the appended claims are intended to cover all such modifications that may fall within the spirit and scope of the invention.

What is claimed is:

1. A decorative electro-luminescent strip for automobiles comprising:
a body having at least one groove disposed in a back thereof and a recess disposed in a front thereof, said recess provided with a raised part therein;
at least one tape placed in said at least one groove of said body;
an electro-luminescent member disposed on said raised part of said recess of said body and connected with cords at a lower portion thereof;
a transparent cover capable of being welded to said front of said body and provided with two projecting ridges respectively disposed at both sides of an inner surface thereof; and,
whereby said decorative electro-luminescent strip can be attached to an automobile body with said cords of said electro-luminescent member connected to power source of said automobile to make said electro-luminescent member emit luminescence capable of passing through said transparent cover, thus performing warning function to night drivers who often have bad view in the dark to avoid car collisions and greatly increasing the safety of said automobile.
